(19) United States
(12) Patent Application Publication
(10) Pub. No.: US 2006/0280393 A1
(43) Pub. Date: Dec. 14, 2006

(54) Ball bearing device, oscillating weight structure for automatic winding and automatic winding timepiece equipped with the same

(76) Inventor: Akira Ebi, Chiba-shi (JP)

Correspondence Address: BRUCE L. ADAMS, ESQ., SUITE 1231, 17 BATTERY PLACE, NEW YORK, NY, 10004, US

(21) Appl. No.: 11/448,615

(22) Filed: Jun. 7, 2006

(30) Foreign Application Priority Data
Jun. 8, 2005 (JP) 2005-168098

(51) Int. Cl. F16C 33/38

(52) U.S. Cl. 384/523

(57) ABSTRACT

To provide a ball bearing device with less possibility that its stable operation is disturbed, an oscillating weight structure for automatic winding and an automatic winding timepiece equipped with the ball bearing device. A ball bearing device 1 suitable for use in an oscillating weight structure for automatic winding timepiece includes an outer ring, an inner ring, a plurality of balls disposed between the outer ring and the inner ring regulated in the radial direction, a retainer provided with a plurality of recessed sections in the circumferential direction at intervals each having an opening in the outer periphery for holding respective one of the balls in the circumferential direction at intervals, and rotatably fitted to the inner ring. Each of the recessed sections of the retainer is formed deeper and wider than the ball in a bottom wall section of the recessed section so that a gap remains between a bottom wall surface of the recessed section and a surface of the ball radially regulated between the outer ring and the inner ring, and can be abut on the ball with the surface opposing to the ball in the circumferential direction in surface sections adjacent to the opening.

### BACKGROUND OF THE INVENTION

1. Field of the Invention

The present invention relates to a ball bearing device suitable to be used for an automatic winding timepiece, and an automatic winding timepiece equipped with the ball bearing device.

2. Description of the Prior Art

A ball bearing device for a timepiece having an outer ring, an inner ring, a plurality of balls disposed between the outer ring and the inner ring in a radially restricted state, a retainer provided with a plurality of recessed sections opening towards the outer periphery at intervals in the circumferential direction for holding the balls at intervals in the circumferential direction and rotatably fitted to the inner ring is known (e.g., Patent Documents 1 and 2).

A conventional ball bearing device 101 of this kind includes the outer ring 110, the inner ring 140 composed of an inner ring body 120 and a holding ring 130, the retainer 150, and balls 170 as shown in FIGS. 14A, 14B, 15A, and 15B.

The outer ring 110 includes a main body 111 of a cylindrical or a circular shape, a pair of inclined circular surfaces 113 and 114 facing each other formed on the inner peripheral surface 112 of the outer ring main body 111, and a gearwheel section 116 formed on one end of the outer peripheral surface 115 of the main body 111.

The body 120 of the inner ring 140 includes a column-shaped or cylindrical shaft section 121 and a flange section or a brim section 122 formed on one end of the shaft section 121, and an inclined circular surface 124 is formed on one side edge 123 of the outer periphery of the brim section 122. The holding ring 130 includes a cylindrical section 132 fitted to the outer periphery 125 of the cylindrical shaft section 121 of the inner ring body 120 with an inner periphery 131 thereof, a flange section or a brim section 133 formed on the outer periphery of an intermediate part of the cylindrical section 132, and an inclined circular surface 135 facing the inclined circular surface 124 is formed on one side edge 134 of the outer periphery of the brim section 133.

There are disposed five spherical balls 170 between the inclined circular surfaces 113, 114 of the outer ring 110 side and the inclined circular surfaces 124, 135 of the inner ring 140 side.

The retainer 150 formed of a circular flat plate 151 is rotatably fitted to the cylindrical shaft section 136 positioned between the brim section 133 of the holding ring 130 of the inner ring 140 and the brim section 122 of the inner ring body 120. The retainer 150 has the recessed sections 153 with substantially semicircle shapes in the outer periphery 152 at intervals in the circumferential direction, and each of the recessed sections 153 holds respective one of the balls 170. The radius of a circle forming the recessed section 153 is a little bit larger than the radius of a sphere of the ball 170.

In the conventional ball bearing device 101 of this kind, when the outer ring 110 is rotated with respect to the inner ring 140 around the center axis C1 in the direction of W1, for example, the balls 170 abutting on the inclined circular surfaces 113, 114 of the outer ring 110 usually move orbitally in the W1 direction while rotating around their axes in the G1 direction, thus rotationally moving with respect to the inclined circular surfaces 124, 135 of the inner ring 140 as shown in FIG. 14A. Note that the retainer 150 also rotates in the W1 direction while pushed by the balls 170 in accordance with the orbital movement of the balls 170 in the W1 direction.

However, in fact, the inside diameter of the retainer 150 is somewhat greater than the outer diameter of the shaft section 136 of the inner ring 140, as much as, for example, Ba (e.g., several tens micrometers through about a hundred micrometers). Therefore, if the retainer 150 takes the position shifted in the H1 direction with respect to the shaft section 136 of the inner ring 140, for example, although three balls 170a, 170b, and 170e out of the five balls 170 push the recess sections 153a, 153b, and 153e of the retainer 150 at areas 154a, 154b, and 154e, which are adjacent to the openings of the respective recess sections and positioned in the W1 direction, in directions of D1, D2, and D5 (i.e., substantially in the W1 direction), respectively, the balls 170c and 170d positioned inside the recess sections 153c and 153d of the retainer 150 abut on areas 155c, 155d adjacent to the bottoms thereof to push the areas 155c, 155d adjacent to the bottoms thereof in directions of D3 and D4, respectively (Assuming that the angles of the force directions D1, D2, D3, D4, and D5 with the directions towards the rotational axis are θD1, θD2, θD3, θD4, and θD5, respectively, the angles θD1, θD2, and θD5 are substantially 90 degrees while the angles θD3 and θD4 are far smaller to be less than 45 degrees.) as shown in FIG. 16A. The torque in the W1 direction does not effectively operate on the retainer 150 moved by the ball 170a, and accordingly, the motion of the retainer 150 might run off the rotational movement around the rotational axis C1 to include an irregular radial motion. Further, in such a condition, the rolling force might not evenly act on each of the balls 170a, 170b, 170c, 170d, and 170e, thus making the movement of the balls 170 also irregular. In such a case, the directions of the force acting between the retainer 150 and the balls 170 might become inconsistent, or the balls 170 might slip without rotation with respect to the inclined circular surfaces 124, 135, 113, and 114 of the inner ring body 120, the holding ring 130, and the outer ring 110, thus causing excessive wear.

In particular, in the condition shown in FIG. 16A for example, not only the circumferential force but also radial force in the −H direction acts on the retainer 150 while the balls 170c and 170d restrict the rotation of the retainer 150, and as shown in FIG. 16B, the retainer 150 inclines in a cross-sectional view including the central axis C1 in response to the pressure in the −H direction, and further abuts on the ball 170a at a point shifted from the center of the ball 170a in the +Z direction as shown in the right area of FIG. 16B and FIG. 16C, which is an enlarged view, thus the retainer 150 receives not only the force in the D1 direction but also the force in the +Z direction.

Therefore, in an adjacent area of the area 154a, which receives the force from the ball 170a in the recess section 153a, a part of the peripheral wall might be deformed in the thickness direction of Z so as to run on (or burrow into) the ball 170 (e.g., the state exaggeratingly illustrated with an imaginary line 156 shown in FIG. 16C). Once such deformation occurs, it becomes easier for the ball 170 to run on (or burrow into) the deformed part, and moreover, the ball 170 runs on or burrows into the part of the peripheral wall so as to further advance the deformation, thus the friction against the rotational movement of the ball 170 or the rotation of the retainer 150 might dramatically be increased, or the rotational movement or the rotation itself might be hindered.

In such a condition, the ball bearing device 101 does not function for practical purposes. As a result, if the ball bearing device 101 is implemented in an oscillating weight of an automatic winding mechanism, the rotation of the oscillating weight might be hindered to make it difficult to effectively winding a mainspring.

Note that in order for avoiding such deformation of the retainer, the retainer needs to be thicker. Since the thicker retainer has greater mass and inertia moment, the performance of the initial motion is degraded.

<Patent Document 1> Japanese Utility Model Application No. 66006 (JP-UM-A-52-156564) microfilm, FIGS. 1-a and 1-b and the corresponding descriptions

<Patent Document 2> UK Patent No. 795,563 specification

The present invention is made in view of the point described above, and an object thereof is to provide a ball bearing device, which has less risk of hindering the stable operation, an oscillating weight structure for automatic winding and an automatic winding timepiece equipped with the ball bearing device.

### SUMMARY OF THE INVENTION

In order for achieving the object described above, the ball bearing device according to the invention includes an outer ring, an inner ring, a plurality of balls disposed between the outer ring and the inner ring in a radially restricted state, a retainer provided with a plurality of recessed sections in the circumferential direction at intervals each having an opening in the outer periphery for holding respective one of the balls in the circumferential direction at intervals, and rotatably fitted to the inner ring. Each of the recessed sections of the retainer is formed deeper and wider than the ball in a bottom wall section of the recessed section so that a gap remains between a bottom wall surface of the recessed section and a surface of the ball radially restricted between the outer ring and the inner ring, and can abut on the surface of the ball opposing in a circumferential direction in surface sections adjacent to the opening of the recessed section.

In the ball bearing device according to the invention, since “the outer ring, the inner ring, a plurality of balls disposed between the outer ring and the inner ring in the radially restricted state” are provided, the inner ring and the outer ring can relatively be rotated. Further, in the ball bearing according to the invention, since “the retainer provided with a plurality of recessed sections, each having an opening in the outer periphery, at intervals in the circumferential direction for holding the balls at intervals in the circumferential direction and rotatably fitted to the inner ring” is further provided, the plurality of balls can be prevented from abutting on or interfering with each other, thus the relative rotation between the inner ring and the outer ring can be performed smoothly. In addition to the above, in the ball bearing device according to the invention, since, in particular, “each of the recessed sections of the retainer is formed deeper and wider than the ball in a bottom wall side of each of the recessed sections so that a gap remains between a surface of the ball radially regulated between the outer ring and the inner ring and a bottom wall surface of each of the recessed sections, and is capable of abutting on the surface of the ball opposing in a circumferential direction in surface sections adjacent to the opening of each of the recessed sections,” the ball disposed in each of the recessed sections of the retainer abuts on the surface opposing to the ball in the circumferential direction in the surface sections adjacent to the opening of the recessed section without abutting on the bottom side surface of the recessed section, thus the balls rotationally moving between the inner and the outer rings surely exert the rotational force in the circumferential direction on the retainer to rotate the retainer.

Namely, in the ball bearing device according the invention, unlike the conventional ball bearing device, since there is no possibility that the ball pushes the wall section of the recessed section of the retainer in the radial direction, there is less possibility that the retainer is shifted in the radial direction or inclined in the thickness direction, or the ball pressed against such a shifted or inclined retainer breaks into the edge section of the opening of the recessed section of the retainer or bends the edge section of the opening in the thickness direction. Therefore, in the ball bearing device according to the invention, there is less possibility that the retainer hinders the rotational movement of the ball or the ball hinders the rotation of the retainer, thus the relative rotation between the inner ring and the outer ring can stably be operated.

Note that there is some gap between the inner ring and the retainer rotatably fitted to the inner ring. In the ball bearing device according to the invention, even in consideration of the size of the gap, namely the difference between the inside diameter of the retainer in the fitting section and the outer diameter of the inner ring in the fitting section, “each of the recessed sections of the retainer is formed deeper and wider than the ball in a bottom wall side of each of the recessed sections so that a gap remains between a surface of the ball radially restricted between the outer ring and the inner ring and a bottom wall surface of each of the recessed sections”. The gap between the surface of the ball and the bottom wall side surface of the recessed section of the retainer is typically in a range of 10 μm through 20 μm or greater. Note that greater or smaller sizes can be acceptable. Meanwhile, the difference between the outer diameter of the inner ring and the inside diameter of the retainer is typically in a range of about 10 μm through 60 μm. Note also that greater or smaller sizes can be acceptable.

Note that in the ball bearing device according to the invention, since “each of the recessed sections of the retainer is formed deeper and wider than the ball in a bottom wall side of each of the recessed sections so that a gap remains between a surface of the ball radially restricted between the outer ring and the inner ring and a bottom wall surface of each of the recessed sections”, the gap formed between the surface of the ball and the bottom wall side surface of the recessed section can function, in any way, as a dust hole for fine powder, which might gradually arise in the operation of the bearing device, thus helping the bearing device operate stably for a long period of time. Note that the dust hole expanded in the circumferential direction can be formed adjacent to the bottom section of the recessed section by significantly setting back the bottom wall side surface of the recessed section so that a gap sufficiently larger than the size necessary for avoiding the abutment between the surface of the ball and the bottom wall side surface of the recessed section is formed between the surface of the ball and the bottom wall side surface of the recessed section.

In the ball bearing device according to the invention, the surface sections adjacent to the opening of the recessed section extend linearly in typical cases. In such cases, the surface sections adjacent to the opening of the recessed section capable of abutting on the surface of the ball opposing in the circumferential direction can be parallel to each other with a substantially constant distance, or can be arranged to have a smaller distance at positions toward the outer radial direction. In the substantially parallel condition or the nearly parallel condition, the balls can surely exert the circumferential force on the retainer as long as the gap remains between the surface of the ball and the bottom wall side surface of the recessed section. Note that the distance can be arranged to be wider at positions toward the outer radial direction, to some extent.

Note also that the surface sections adjacent to the opening of the recessed section can be curved convexly or concavely with respect to the opposing ones of the surface sections instead of being parallel to each other.

The retainer can be provided with notches if desired. In such a case, the mass and the inertia moment of the retainer can be suppressed to the minimum. The notches can be located in the inner peripheral surface or in the outer peripheral surface, or can be openings formed in the intermediate sections in the radial direction.

Further, the retainer is typically formed of a plain plate member with a constant thickness, but can be formed to have an outer section in the radial direction thinner than an inner section in the redial direction. Also in such a case, the inertia moment of the retainer can be suppressed to the minimum. In this case, the outer section in the radial direction of the retainer capable of abutting on the surface section of the ball oriented in the circumferential direction is typically formed as a thin-wall section.

In this case, the retainer can be an integrated member, or alternatively composed of a thick-wall ring section positioned inner in the radial direction and a thin-wall ring section fitted to the thick-wall ring section in an inner peripheral side and positioned outer in the radial direction.

In the ball bearing device according to the invention, the inner peripheral surface of the outer ring typically includes two inclined circular surfaces. Meanwhile, the inner ring includes an inner ring body with an inclined circular outer peripheral surface and a holding ring with an inclined circular surface and fitted to the inner ring body, and the holding ring includes a cylindrical section rotatably fitted to the retainer, and positioned between the inclined circular surface of the inner ring body and the inclined circular surface of the holding ring. Note that, instead of fitting the holding ring to the outer periphery of the shaft section of the inner ring body, the holding ring can be fitted to the inner periphery side of the cylindrical shaft section of the inner ring body, and the retainer can directly be fitted to the cylindrical shaft section of the inner ring body.

In the ball bearing device according to the invention, the retainer is typically formed of a circular plate.

The ball bearing device according to the invention can be applied to everywhere between two members relatively rotating such as an oscillating weight structure for automatic winding in an automatic winding timepiece. In this case, the outer ring of the ball bearing device is typically fixed to the oscillating weight.

### BRIEF DESCRIPTION OF THE SEVERAL VIEWS OF THE DRAWINGS

A preferred form of the present invention is illustrated in the accompanying drawings in which:

FIG. 1 show ball bearing devices of a preferred embodiment according to the invention, FIG. 1A is a partial broken plan explanatory view, FIG. 1B is an enlarged explanatory view corresponding to the portion IB surrounded by a circle in FIG. 1A;

FIG. 2 show vertical cross-sections of the ball bearing device shown in FIG. 1, and FIG. 2A is a cross-sectional explanatory view along the IIA-IIA line in FIG. 1A, FIG. 2B is an enlarged explanatory view corresponding to the portion IIB surrounded by a circle in FIG. 2A;

FIG. 3 are for explaining the operation of the ball bearing device shown in FIG. 1, FIG. 3A is a horizontal cross-sectional explanatory view (In the cross-sectional view, hatching for the retainer is omitted for the sake of easier view, and the shaft structure of the inner ring is not shown.) showing the force exerted on retainer in a plane (cross-sectional view along the IIIA-IIIA line in FIG. 2) similar to the broken section in the right part of FIG. 1A, FIG. 3B is an enlarged explanatory view corresponding to the portion IIIB surrounded by a circle in FIG. 3A, and FIG. 3C is an enlarged explanatory view, similar to FIG. 3B, in the condition with the retainer shifted in the opposite side to the side the retainer is shifted to in the condition shown in FIG. 3B;

FIG. 4 show ball bearing devices of a modified example according to the invention, FIG. 4A is a horizontal cross-sectional explanatory view (In the cross-sectional view, hatching for the retainer is omitted for the sake of easier view, and the shaft structure of the inner ring is not shown (the same applies hereinafter).) similar to the broken section in the right part of FIG. 1A, and FIG. 4B is an enlarged explanatory view corresponding to the portion IVB surrounded by a circle in FIG. 4A;

FIG. 5 show ball bearing devices of another modified example according to the invention, and FIG. 5A is a horizontal cross-sectional explanatory view similar to FIG. 4A, FIG. 5B is an enlarged explanatory view corresponding to the portion VB surrounded by a circle in FIG. 5A;

FIG. 6 show ball bearing devices of still another modified example according to the invention, and FIG. 6A is a horizontal cross-sectional explanatory view similar to FIG. 4A, FIG. 6B is an enlarged explanatory view corresponding to the portion VIB surrounded by a circle in FIG. 6A;

FIG. 7 shows a ball bearing device of still another modified example according to the invention, and is a horizontal cross-sectional explanatory view similar to FIG. 4A;

FIG. 8 show ball bearing devices of still other modified examples according to the invention, and each of FIG. 8A and FIG. 8B is a horizontal cross-sectional explanatory view similar to FIG. 4A;

FIG. 9 shows a ball bearing device of still another modified example according to the invention, and is a horizontal cross-sectional explanatory view similar to FIG. 4A;

FIG. 10 show ball bearing devices of still another modified example according to the invention, and FIG. 10A is a horizontal cross-sectional explanatory view similar to FIG. 2A, FIG. 10B is an enlarged explanatory view corresponding to the portion XB surrounded by a circle in FIG. 10A;

FIG. 11 show ball bearing devices of still another modified example according to the invention, and FIG. 11A is a horizontal cross-sectional explanatory view similar to FIG. 2A, FIG. 11B is an enlarged explanatory view corresponding to the portion XIB surrounded by a circle in FIG. 11A;

FIG. 12 show ball bearing devices of still another modified example according to the invention, and FIG. 12A is a horizontal cross-sectional explanatory view similar to FIG. 2A, FIG. 12B is an enlarged explanatory view corresponding to the portion XIIB surrounded by a circle in FIG. 12A;

FIG. 13 is an exploded (developed) perspective explanatory view of a timepiece implementing an automatic winding mechanism equipped with a ball bearing device of a preferred embodiment of the invention;

FIG. 14 show conventional ball bearing devices, and FIG. 14A is a partial broken plan explanatory view similar to FIG. 1A, FIG. 14B is an enlarged explanatory view corresponding to the portion XIVB surrounded by a circle in FIG. 14A;

FIG. 15 are cross-sectional explanatory views along the XVA-XVA line of the ball bearing device shown in FIG. 14, and FIG. 15B is an enlarged explanatory view corresponding to the portion XVB surrounded by a circle in FIG. 15A; and

FIG. 16 show operation of the ball bearing devices shown in FIG. 14, and FIG. 16A is a horizontal cross-sectional explanatory view similar to FIG. 3A, FIG. 16B is a cross-sectional explanatory view along the XVIB-XVIB line in FIG. 16A, and FIG. 16C is an enlarged explanatory view corresponding to the portion XVIC surrounded by a circle in FIG. 16B.

### DETAILED DESCRIPTION OF THE PREFERRED EMBODIMENTS

Some of preferred embodiments of the % invention will hereinafter be explained with reference to preferred examples shown in the accompanying drawings.

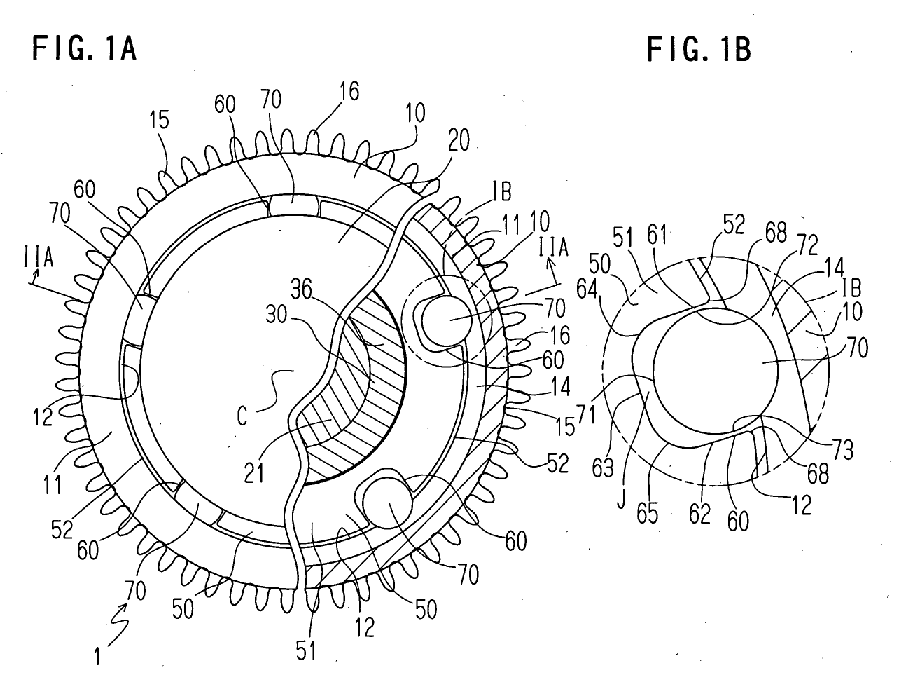

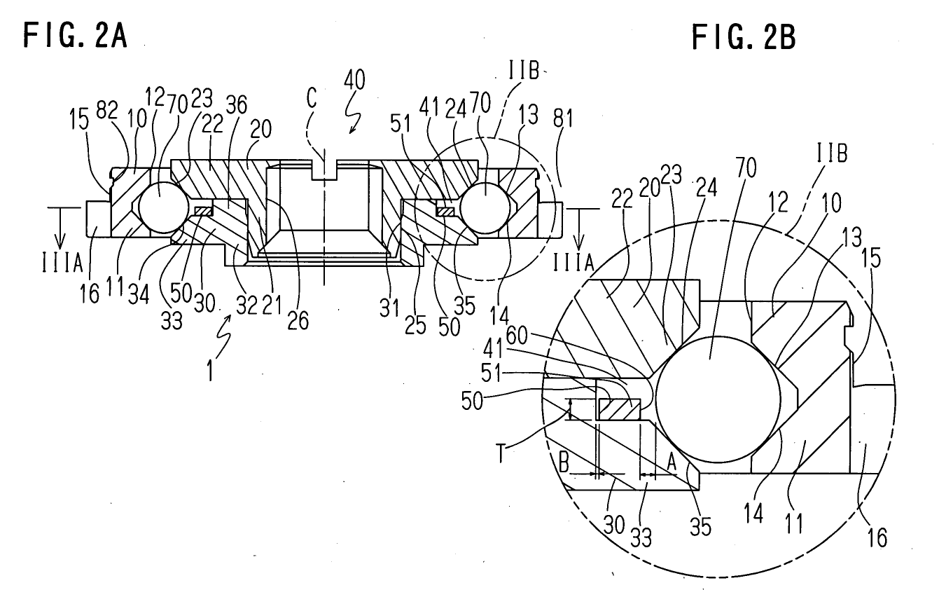

A ball bearing device 1 of a preferred example of the invention shown in FIGS. 1A, 1B, 2A, and 2B has an outer ring 10, an inner ring 40 composed of an inner ring body 20 and a holding ring 30, a retainer 50, and balls 70. In the example described below, with a ball bearing device used for an automatic winding mechanism of a timepiece in mind, one having about five balls 70 with diameter of about 0.6 mm supported by the retainer 50 with constant intervals will be explained as an example. Therefore, those corresponding to the above are exemplified as the sizes of various gaps or the like. If the size or the usage of the ball bearing device is different therefrom, the sizes of various sections can obviously be different.

The outer ring 10 includes a main body 11 of a cylindrical or a circular shape, a pair of inclined circular surfaces 13 and 14 facing each other formed on the inner peripheral surface 12 of the outer ring main body 11, and a gearwheel section 16 formed on one end of the outer peripheral surface 15 of the main body 11. The inclined surfaces 13, 14 incline at the same angles with the central axis C so as to face each other. In this example, the angle of inclination is 45 degrees, and an angle formed with the inclined surfaces 13, 14 is 90 degrees. Note that the angle of inclination can be greater or smaller than 45 degrees. Note also that the angles of inclination of the inclined surfaces 13, 14 can be different from each other in some cases.

The body 20 of the inner ring 40 includes a column-shaped or cylindrical shaft section 21 and a flange section or a brim section 22 formed on one end of the shaft section 21, and an inclined circular surface 24 is formed on one side edge 23 of the outer peripheral of the brim section 22.

The holding ring 30 includes a cylindrical section 32 fitted to the outer periphery 25 of the cylindrical shaft section 21 of the inner ring body 20 with an inner periphery 31 thereof, a flange section or a brim section 33 formed on the outer periphery of an intermediate part of the cylindrical section 32, and an inclined circular surface 35 facing the inclined circular surface 24 is formed on one side edge 34 of the outer periphery of the brim section 33.

The inclined surfaces 24, 35 also incline at the same angles with the central axis C so as to face each other. The angles of inclination of the inclined surfaces 24, 35, which are typically the same as the inclination angles of the inclined surfaces 13, 14, are 45 degrees in the example, and the angle formed with each other is 90 degrees. Note that the inclination angles of the inclined surfaces 24, 35 can be different from the inclination angles of the inclined surfaces 13, 14. Note also that the inclination angles of the inclined surfaces 24, 35 can be different from each other in some cases.

There are disposed five spherical balls 70 between the inclined circular surfaces 13, 14 of the outer ring 10 side and the inclined circular surfaces 24, 35 of the inner ring 40 side.

The retainer 50 formed of a circular flat plate 51 is rotatably fitted to the cylindrical shaft section 36 positioned between the brim section 33 of the holding ring 30 of the inner ring 40 and the brim section 22 of the inner ring body 20. The length of the shaft section 36 in the axis direction (the direction in which the center axis C extends) is about 0.2 mm, for example, and the retainer 50 shaped like a plain plate is fitted to this circular gap 41. The thickness T of the retainer 50 shaped like a plain plate is, for example, about 0.1 mm. Note that either of the sizes can be greater or smaller. Note also that the retainer 50 shaped like a plain plate is preferably as thin as possible providing enough rigidity is maintained, and the thickness T thereof is, for example, one sixth of the diameter of the ball 70 or less. The difference B between the diameter (inside diameter) of a center hole 53 of the retainer 50 and the outer diameter of the cylindrical shaft section 36 is made as small as possible to be, for example, about 10 μm through 60 μm. The lower limit value of the difference B can be smaller as long as smooth rotation of the retainer 50 can be allowed. If the manufacturing cost can be increased to some extent, the upper limit of the difference B can be lowered.

Note that in the case in which the tubular shaft section 36 of the holding ring 30 is fitted inside the shaft section 21 of the inner ring body 20, or the holding ring 30 is formed of a circular member fitted to the shaft section 21 of the inner ring body 20, the retainer 50 is not fitted to the shaft section 36 of the holding ring 30 but fitted to the shaft section 21 of the inner ring body 20 instead.

The retainer 50 has recessed sections 60 opened in the outer periphery 52 at intervals in the circumferential direction, and holds the balls 70 inside the respective recessed sections 60.

Each of the recessed sections 60 of the retainer 50 has the same shape, and disposed at constant intervals in the circumferential direction. As seen from the enlarged view shown in FIG. 1B, the recessed section 60 has a pair of parallel sidewall sections or parallel side surface sections 61, 62 and a bottom wall section or a bottom surface section 63 extending in a direction perpendicular to the sidewalls 61, 62, the bottom wall section 63 and the sidewall sections 61, 62 adjacent thereto being smoothly connected to each other via circular arc curved sections 64, 65. Note that the curved sections 64, 65 are not necessarily shaped as a circular arc with a constant radius as long as the curved sections 64, 65 curve smoothly and are composed of sections with curvature radius smaller than the radius of the ball 70.

The distance between the sidewall sections 61, 62 as surface sections adjacent to the opening of the recessed section 60 is slightly greater than the diameter (e.g., about 0.6 mm. The greater or smaller values can also do.) of the ball 70, and the imaginary line passing through the middle of the sidewall sections 61, 62 and extending in parallel to the sidewall sections 61, 62 radially extends exactly from the rotational center axis C outward in the radius direction. The circular arc sections 64, 65 are circular arcs with the same radius smaller than the radius of the ball 70. The bottom wall section 63 of the recessed section 60 is sufficiently set back inward in the radius direction so that a gap J is formed between the bottom wall section 63 of the recessed section 60 and an opposing surface section 71 of the ball 70 in the condition in which the ball 70 is positioned in the radius direction between the inclined circular sections 13, 14, 24, and 35 of the outer ring 10 and the inner ring 20.

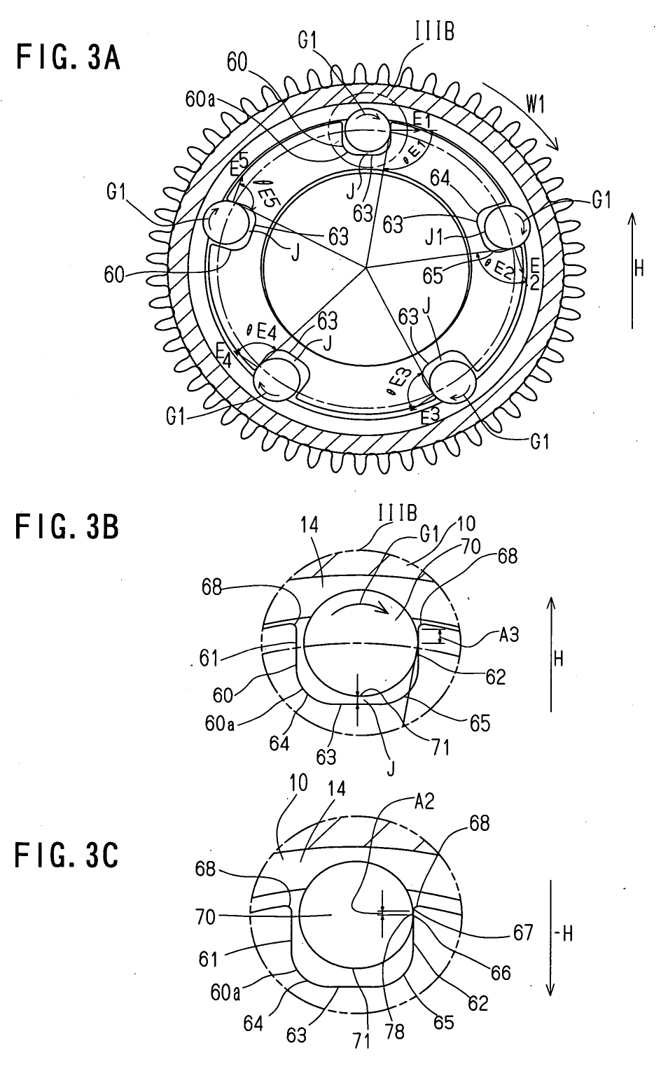

In further detail, as shown in FIG. 3A, the bottom wall section 63 is formed so that the gap J must remain between the bottom wall section 63 of the recessed section 60a positioned in the H direction and the opposing surface of the ball 70 in the condition in which the retainer 50 is shifted in the H direction with respect to the shaft section 36 of the inner ring 40. In such a case in which the gap J becomes the smallest, the size A of the gap J is, for example, about 10 μm through 20 μm. Namely, even when the retainer 50 is positioned with the maximum eccentric relation to the inner ring 40 in accordance with the difference B between the diameter of the central hole 53 of the retainer 50 and the outer diameter of the cylindrical shaft section 36 of the holding ring 30 of the inner ring 40, the size A of the gap J is at least 10 μm or larger. Note that if the cost necessary for improving manufacturing tolerance can be reduced or the higher manufacturing cost can be allowed, it can be smaller than 10 μm. Note also that if the recessed section 60 of the retainer 50 becomes excessively deeper, the radial length of the bottom wall section 63 of the recessed section 60 is decreased, and accordingly, the rigidity of the retainer 50 might be lowered. Therefore, there is a limitation in the depth of the recessed section 60.

Further, in the condition in which the ball 70 is positioned in the radius direction between the inclined circular sections 13, 14, 24, and 35 of the outer ring 10 and the inner ring 20, surface sections 72, 73 in the surface sections of the ball 70 opposite to each other in the diameter direction and oriented in the circumferential direction of the bearing 1 face the sidewall sections 61, 62, respectively. Namely, the depth of the recessed section 60 is sufficiently greater than the radius of the ball 70.

In further detail, as shown in FIG. 3C, the linear sidewall sections 61, 62 are formed long enough so that a section 66 in the linear sidewall sections 61, 62, abutting on the opposing surface sections 72, 73 of the ball 70 is positioned more inner than the outer end section 67 of the linear sidewall section as much as the length of A2 when the retainer 50 is positioned shifted as much as possible in the −H direction (the direction for making the ball 70 protrude from the recessed section 60a) with respect to the inner ring 40. Here, the length A2 is, for example, about 50 μm (Note that as shown in FIG. 3B, when the retainer 50 is in an eccentric position in the H direction, a distance A3 between the section 66 in the linear sidewall sections 61, 62, abutting on the opposing surface sections 72, 73 of the ball 70 and the outer end section 67 of the linear sidewall section is obviously greater than 50 μm.) Note that if there are no possibilities of interference between the outer periphery section 52 of the retainer 50 and the outer ring 10, the length A2 can be greater. Further, if desired, the length A2 can be smaller as long as there are no possibilities of deformation of a corner section 68 at the tip of the opening of the recessed section 50. Note also that the corner section 68 continuously connected to the outer end section 67 of the linear sidewall sections 61, 62 is formed to have a rounded shape. Here, the radial length of the corner section 68 can be ignored.

Note that the distance between the linear sidewall sections 61, 62 of the recessed section 60 and the maximum diameter sections of the ball 70 accommodated in the recessed section 60 is, for example, about 10 μm through 50 μm as a whole. Note also that greater or smaller sizes can be acceptable.

The sidewall sections 61, 62 of the recessed section 60 are smoothly connected to the adjacent portions of the outer peripheral surface 52 of the retainer 50 via curved connecting sections 66, 67. In other words, in this example, the sidewall sections of the recessed section 60 is composed of the linear sidewall sections 61, 62 and the curved end sections 68.

In the ball bearing device 1 configured as described above, when the outer ring 10 is rotated with respect to the inner ring 40 around the center axis C in the direction of W1, for example, the balls 70 abutting on the inclined circular surfaces 13, 14 of the outer ring 10 move orbitally in the W1 direction while rotating around their axes, thus rotationally moving with respect to the inclined circular surfaces 24, 35 of the inner ring 40 as shown in FIG. 3A. Note that the retainer 50 also rotates in the W1 direction while pushed by the balls 70 in accordance with the orbital movement of the balls 70 in the W1 direction.

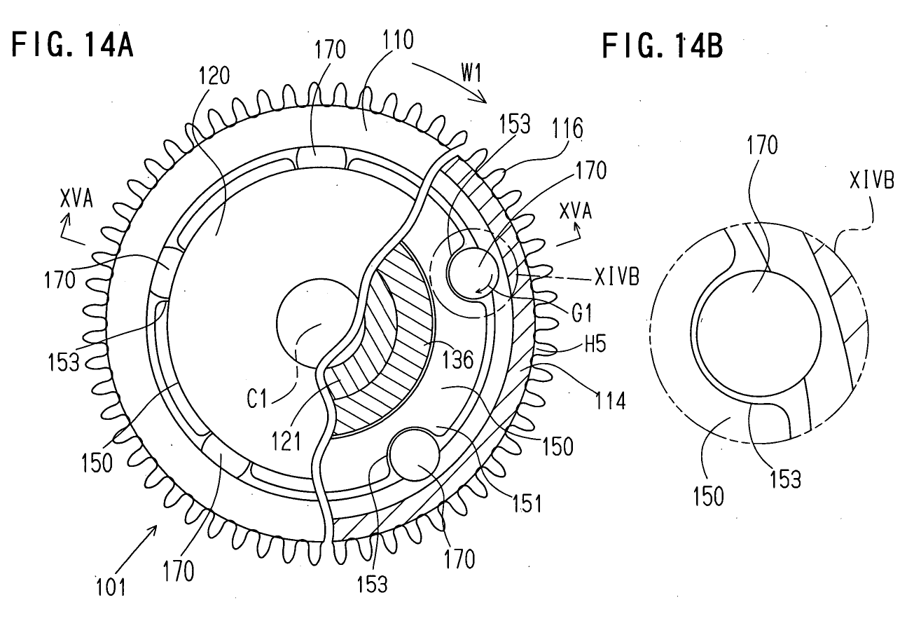

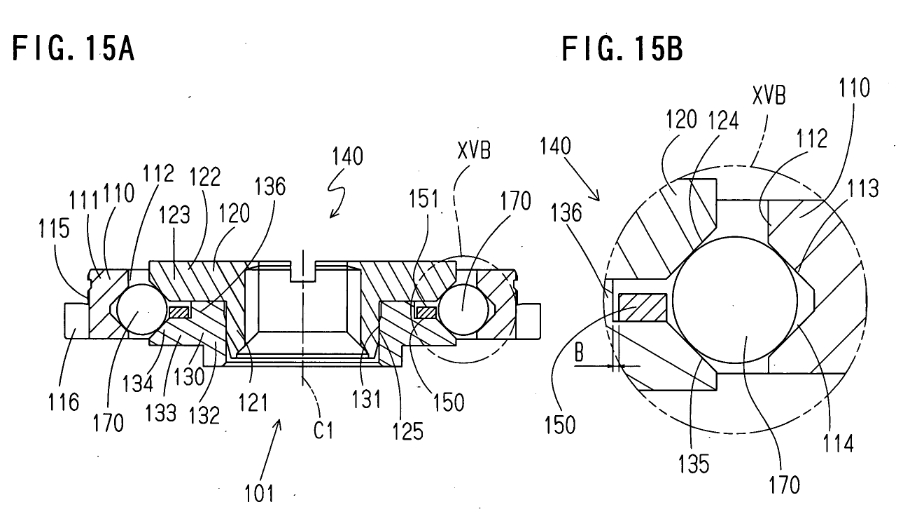

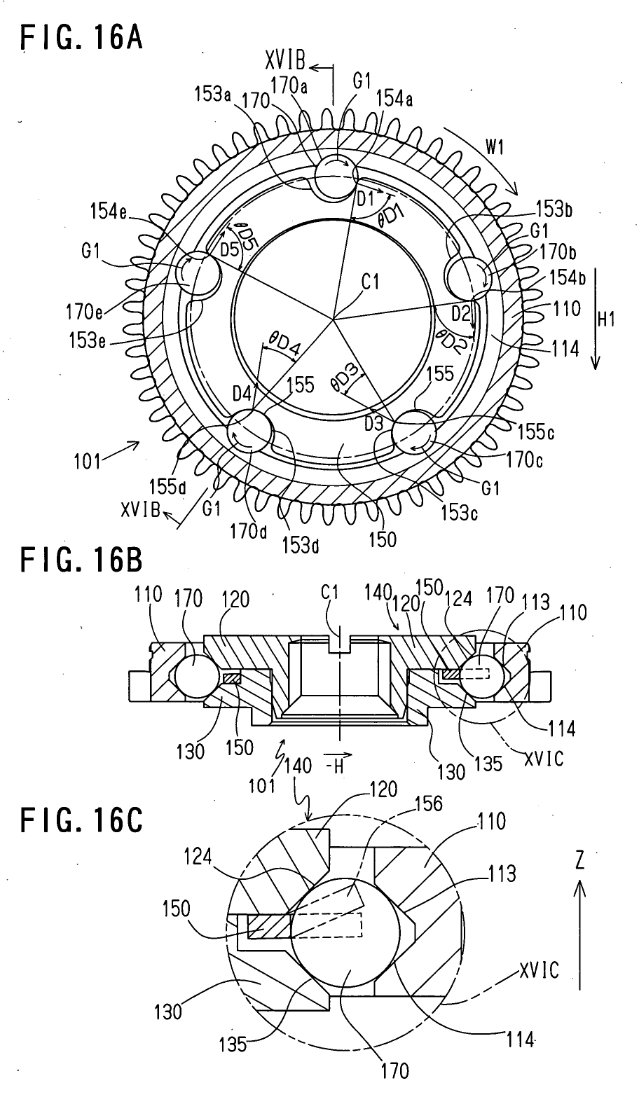

Note also that in a practical sense the inside diameter of the retainer 50 is somewhat greater than the outer diameter of the shaft section 36 of the inner ring 40 as much as, for example, the length B. Therefore, the retainer 50 may be positioned, for example, shifted in the H direction with respect to the shaft section 36 of the inner ring 40 as shown in FIG. 3A. In the ball bearing device 1, since the gap J remains between the bottom wall section 63 of the recessed section 60 of the retainer 50 and the opposing surface section 71 of the ball 70, there is no possibility that the ball 70 exerts force inward in the radial direction on the bottom wall section 63 of the retainer 50. Further, in the ball bearing device 1, since the (curvature) radius of the circular arc wall sections 64, 65 adjacent to the bottom wall section 63 is smaller than the radius of the ball 10, there are no possibilities that the surface of the ball 70 abuts on the circular arc wall sections 64, 65. Therefore, unlike the case with the conventional ball bearing device 101 shown in FIGS. 14 through 16, there is less possibility that the ball 70 exerts force inward in the radial direction or any inclined directions close to the radial direction on the circular arc wall sections 64, 65 of the recessed section 60 of the retainer 50. Further, in the ball bearing device 1, since the recessed section 60 is provided with the sidewall sections 61, 62 extending in parallel to the direction substantially along the radial direction, and the depth of the recessed section 60 is sufficiently greater than the radius of the ball 70, the ball 70 faces the sidewall sections 61, 62 in the surface sections 72, 73 opposite to each other in the diameter direction oriented in the circumferential direction of the bearing device 1, the ball 70 always abuts on the opposing surface section of the recessed section 60 in the surface sections 72, 73 in actuality. Therefore, the force the ball 70 exerts on the retainer 50 is always in the circumferential direction in actuality. Accordingly, if the retainer 50 is temporarily positioned in the eccentric position, the balls 70 exert the turning force in the W1 direction on the retainer 50 regardless of the position of the retainer 50. Namely, in the case of the example, the balls 70a, 70b, 70c, 70d, and 70e (denoted with the reference numeral 70 collectively or with no distinction) accommodated in the respective recessed sections 60a, 60b, 60c, 60d, and 60e (denoted with the reference numeral 60 collectively or with no distinction) push, in the circumferential direction W1, the sidewalls of the respective recessed sections 60a, 60b, 60c, 60d, and 60e corresponding to the directions E1, E2, E3, E4, and E5 forming angles θE1, θE2, θE3, θE4, and θE5 with the center C, to rotate the retainer 50 in the W1 direction.

Therefore, in the ball bearing device 1, unlike the conventional ball bearing device 101 shown in FIGS. 14 through 16, there is less possibility that the ball deforms the part of the retainer adjacent to the recessed section thereof or bites into the deformed wall section of the recessed section of the retainer, thus hindering the rotation of the retainer or being hindered by the retainer and so on in the rotation of the ball itself.

Further, in the ball bearing device 1, since the gap J is formed between the bottom wall section 63 of the recessed section 60 and the opposing surface section 71 of the ball 70, even if any fine powder arises in accordance with the constant impact between the balls 70 and the inside walls of the recessed sections 60 of the retainer 50 or the rotational movement of the balls 70 in the ball bearing device 1, the fine powder can be stored in the gap J, which can function as a dust hole in any way, thus the operations of the balls 70 of the ball bearing device 1 are maintained stable for a long period of time with ease. In the case in which the device 1 is kept oiled enough for forming thin oil films on the surfaces of the balls 70, the fine powder can be stored in the gap J in such conditions as wrapped with the lubrication oil or aggregated in the lubrication oil.

The ball bearing device 1 can support relative rotation when the outer ring 10 and the inner ring 40 are respectively attached to members rotating relatively to each other.

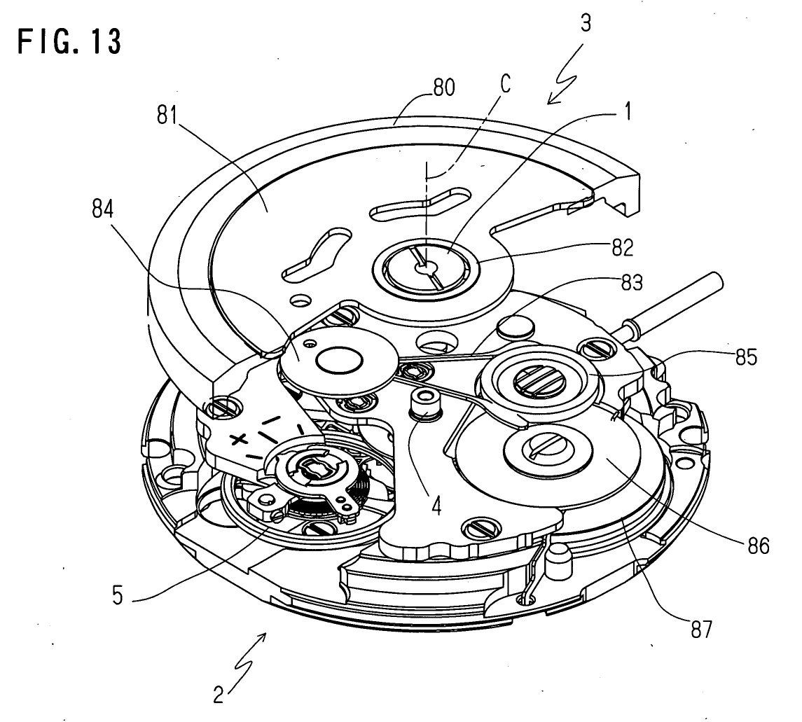

FIG. 13 shows an example applying the ball bearing device 1 between an oscillating weight 80 and a shaft 4 in an automatic winding mechanism 3 of a timepiece 2.

In this example, as shown in FIG. 13 and an imaginary line of FIG. 2A in addition, the outer periphery 15 of the outer ring 10 of the ball bearing device 1 is fitted to a center hole 82 of a rotating conical member 81 of the oscillating weight 80, shaped like a sector plate. A ball bearing shaft 4 supported by a supporting member such as a barrel and train wheel bridge of the timepiece 2 is fitted to the center hole 26 of the main body 20 of the inner ring 40 of the ball bearing device 1. Here, the oscillating weight structure for automatic winding includes the oscillating weight 80 and the ball bearing device 1.

The gearwheel section 16 of the outer ring 10 fixed to the conical member 81 of the oscillating weight 80 is meshed with a first transmission wheel 84 equipped with a pawl lever 83, and the pawl lever 83 is engaged with a ratchet section oriented in one direction provided to a second transmission wheel 85. The second transmission wheel 85 is meshed with a ratchet wheel 86 with a pinion section.

Therefore, when the force for rotating the oscillating weight 80 around the shaft 4 is caused by a change in orientation or an accelerated motion of the timepiece 2 and acts on the oscillating weight 80, the oscillating weight 80 rotatably supported around the shaft 4 via the ball bearing device 1 is rotated around the center axis C, and the rotation of the oscillating weight 80 is converted to the one way rotation of the second transmission wheel 85 via the first transmission wheel 84 and the pawl lever 83 to rotate the ratchet wheel 86, thus winding a mainspring in a barrel drum 87.

In the timepiece 2, since each of the balls 70 of the ball bearing device 1 implemented in the automatic winding mechanism 30 abuts on the linear sidewall section 61 or 62 of the recessed section to push the sidewall section 61 or 62 in the circumferential direction without abutting on the bottom wall section 63 of the recessed section 60 of the retainer 50 regardless of the posture of the timepiece 2 or the position of the retainer 50 the rotational force in the circumferential direction is surely applied to the retainer 50.

Therefore, if the retainer 50 is accidentally positioned in an eccentric position at a moment (of an initial motion) when the oscillating weight 80 starts moving, the balls 70 can surely apply the rotational force to the retainer 50. Accordingly, the retainer 50 can surely and smoothly start rotating. And further, if a certain ball 70 is accidentally hard to rotate for some reasons, the certain ball 70 is pushed to start rotating by the sidewall section 61 or 62 of the recessed section 60 of the retainer 50 pushed and rotated by other balls. And then the certain ball 70 can continue to surely apply the rotational force to the retainer 50 with the other balls. Therefore, since the retainer 50 can surely and smoothly rotate, there is less possibility of deformation of the sidewall sections 61, 62 and so on of the retainer 50 by the balls 70. Therefore, the rotational movement of the balls and the rotation of the retainer 50 can surely and smoothly be performed, thus the oscillating weight 80 can surely and smoothly be rotated. As a result, every time the posture of the timepiece 2 changes, winding up of the mainspring by the ratchet wheel 86 can surely (efficiently) be performed. Further, as described above, since the gap J can function as the dust hole in any way, the stable operations are maintained for a long period of time with ease. In the above, the way of connection or linkage between the oscillating weight 80 and the barrel drum can be different.

In the timepiece 2, a gear train rotationally driven by the driving force of the mainspring thus constantly winded up rotates time displaying hands with a speed controlled by a balance-with-hairspring 5 to perform the time display.

The recessed section of the retainer is formed to be deep and wide in the bottom wall side thereof so that a gap remains between the bottom wall surface of the recessed section and the surface of the ball regulated in the radial direction between the outer and inner rings. The sidewall sections need not to be parallel to each other as long as the surface section adjacent to the opening of the recessed section can abut on the surfaces of the ball facing thereto in the circumferential direction.

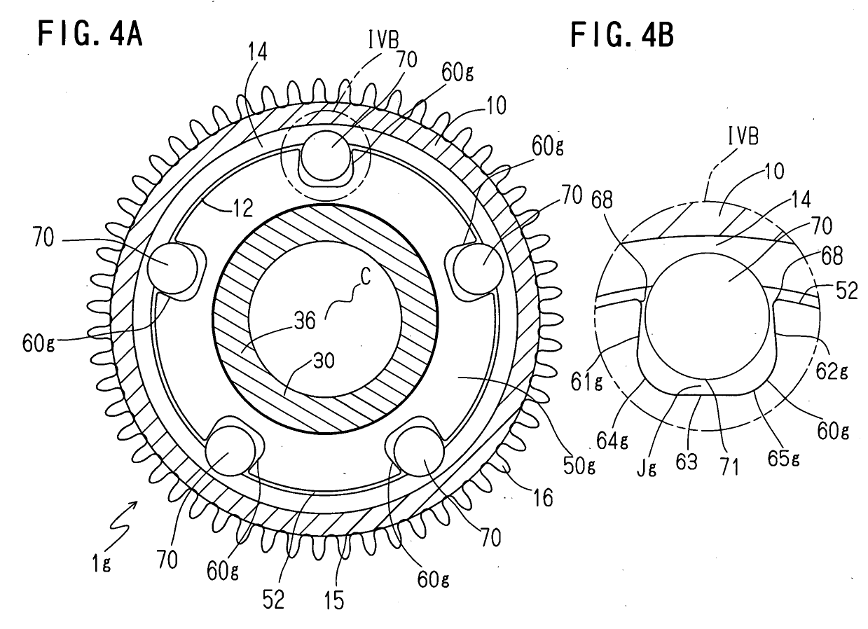

As shown in FIGS. 4A and 4B, a ball bearing device 1g can be equipped with a retainer 50g having recessed sections 60g each provided with linear sidewall sections 61g, 62g inclined so that the distance between the sidewall sections 61g, 62g becomes smaller in accordance with the distance from the center axis C increasing. The inclination of the sidewall sections 61g, 62g can be stronger to some extent providing the radial force applied to the sidewall sections 61g, 62g by the ball 70 when the ball abuts on the sidewall sections 61g, 62g is negligible in actuality in comparison with the force applied to the sidewall sections 61g, 62g in the circumferential direction. In FIGS. 4A and 4B, the same components, elements, and sections as those of the ball bearing device 1 shown in FIGS. 1 through 3 are denoted with the same reference numerals, and those corresponding but partially different are denoted with the reference numerals with a subscript of g.

In the ball bearing device 1g, curved sections 64g, 65g adjacent to the bottom section have a smaller curvature radius than the radius of the ball 70 similarly to the curved sections 64, 65. Note that the sidewall sections 61g, 62g incline so as to come closer to each other in the more outer sections, and accordingly, if the curved section is formed of a part of a circle, the curved section becomes a circular arc with a center angle larger than 90 degrees. Except for this point, the curved sections are configured similarly to the curved sections 64, 65.

Also in this ball bearing device 1g, since the ball 70 does not abut on the bottom wall section 63 or the curved sections 64g, 65g adjacent thereto in the recessed section 60g whether or not the retainer 50g is positioned eccentrically, there is no possibility that the ball 70 applies the force in the radial direction to the retainer 50g via the recessed section 60g. Further, also in this ball bearing device 1g, since the ball 70 exerts the force in the circumferential direction of the retainer 50g on the sidewall sections 61g, 62g of the recessed section 60g whether or not the retainer 50g is positioned eccentrically, there is less possibility that the ball 70 deforms the sidewall sections 61g, 62g of the retainer 50g and so on in the thickness direction, thus the retainer 50g can smoothly be rotated. Therefore, in the ball bearing device 1g equipped with the retainer 50g, the outer ring 10 can smoothly be rotated with respect to the inner ring 40 regardless of the posture and so on.

Further, also in the ball bearing device 1g, since a gap Jg is formed between the bottom wall section 63 of the recessed section 60g and the opposing surface section 71 of the ball 70, even if the fine powder arises, the fine powder can be stored in the gap Jg functioning as a dust hole in any way, thus the operations of the ball 70 of the ball bearing device 1g are maintained stable for a long period of time with ease. In the case of this example, since the sidewall sections 61g, 62g are widened towards the back of the recessed section 60g in any way, the gap Jg becomes relatively large, thus the function as the dust hole can further be improved.

Note that the sidewall sections can be inclined so that the distance between the sidewall sections increases, instead of decreases, in accordance with the distance from the center axis C increasing, providing the inclination is as small as that of the sidewall sections 61g, 62g shown in FIGS. 4A and 4B.

Further, the recessed section of the retainer is formed to be deep and wide in the bottom wall side thereof so that a gap remains between the bottom wall surface of the recessed section and the surface of the ball regulated in the radial direction between the outer and inner rings. The sidewall sections can convexly be curved so as to protrude inside the recessed section as long as the surface section adjacent to the opening of the recessed section can abut on the surfaces of the ball facing thereto in the circumferential direction.

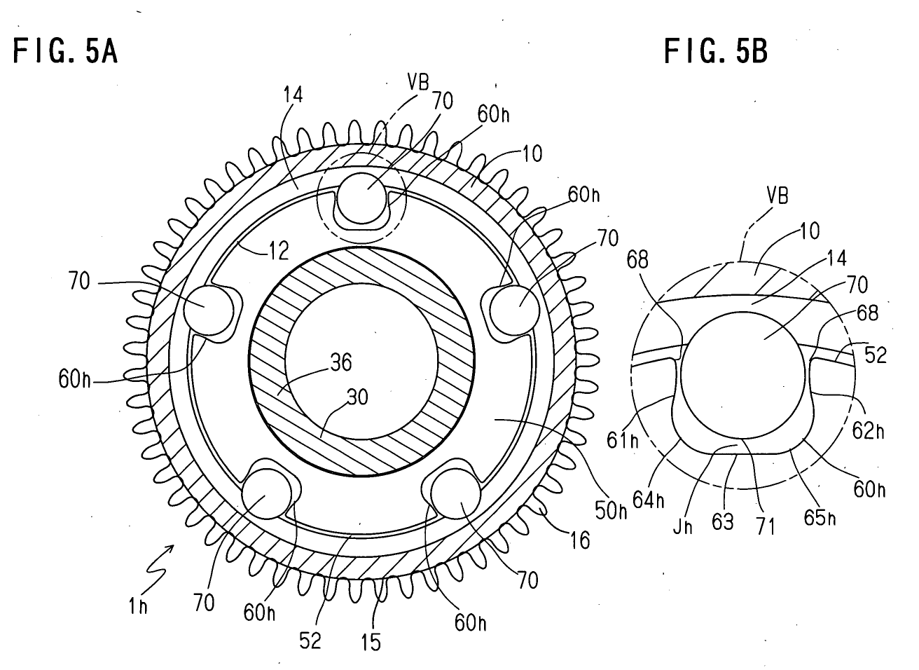

As shown in FIGS. 5A and 5B, a ball bearing device 1h can be equipped with a retainer 50h having recessed sections 60h each provided with sidewall sections 61h, 62h convexly curved towards the opposing sidewall section. In this case, the contact between the convexly curved section of each of the sidewall sections 61h, 62h and the convexly curved section of the spherical surface of the ball 70 can be kept as a point contact in actuality.

In FIGS. 5A and 5B, the same components, elements, and sections as those of the ball bearing device 1 shown in FIGS. 1 through 3 are denoted with the same reference numerals, and those corresponding but partially different are denoted with the reference numerals with a subscript of h.

In the ball bearing device 1h, curved sections 64h, 65h adjacent to the bottom section have a smaller curvature radius than the radius of the ball 70 similarly to the curved sections. 64, 65. Note that, since the sidewall sections 61h, 62h are convexly curved, the sidewall sections 61h, 62h incline so as to come closer to each other in the more outer sections, and accordingly, if the curved section is formed of a part of a circle, the curved section becomes a circular arc with a center angle larger than 90 degrees. Except for this point, the curved sections are configured similarly to the curved sections 64, 65.

Also in this ball bearing device 1h, since the ball 70 does not abut on the bottom wall section 63 or the curved sections 64, 65 adjacent thereto in the recessed section 60h whether or not the retainer 50h is positioned eccentrically, there is no possibility that the ball 70 applies the force in the radial direction to the retainer 50h via the recessed section 60h. Further, also in this ball bearing device 1h, since the ball 70 exerts the force substantially in the circumferential direction of the retainer 50h on the sidewall sections 61h, 62h of the recessed section 60h whether or not the retainer 50h is positioned eccentrically, there is less possibility that the ball 70 deforms the sidewall sections 61h, 62h of the retainer 50h and so on in the thickness direction, thus the retainer 50h can smoothly be rotated. Therefore, in the ball bearing device 1h equipped with the retainer 50h, the outer ring 10 can smoothly be rotated with respect to the inner ring 40 regardless of the posture and so on.

Further, also in the ball bearing device 1h, since a gap Jh is formed between the bottom wall section 63 of the recessed section 60h and the opposing surface section 71 of the ball 70, even if the fine powder arises, the fine powder can be stored in the gap Jh functioning as a dust hole in any way, thus the operations of the ball 70 of the ball bearing device 1h are maintained stable for a long period of time with ease. Also in the case of this example, since the sidewall sections 61h, 62g are widened towards the back of the recessed section 60h in anyway, the gap Jh becomes relatively large, thus the function as the dust hole can further be improved.

Further, the recessed section of the retainer is formed to be deep and wide in the bottom wall side thereof so that a gap remains between the bottom wall side surface of the recessed section and the surface of the ball regulated in the radial direction between the outer and inner rings. The sidewall sections can concavely be curved so as to be concaved from the recessed section, instead of convexly curved so as to protrude inside the recessed section, as long as the surface section adjacent to the opening of the recessed section can abut on the surfaces of the ball facing thereto in the circumferential direction.

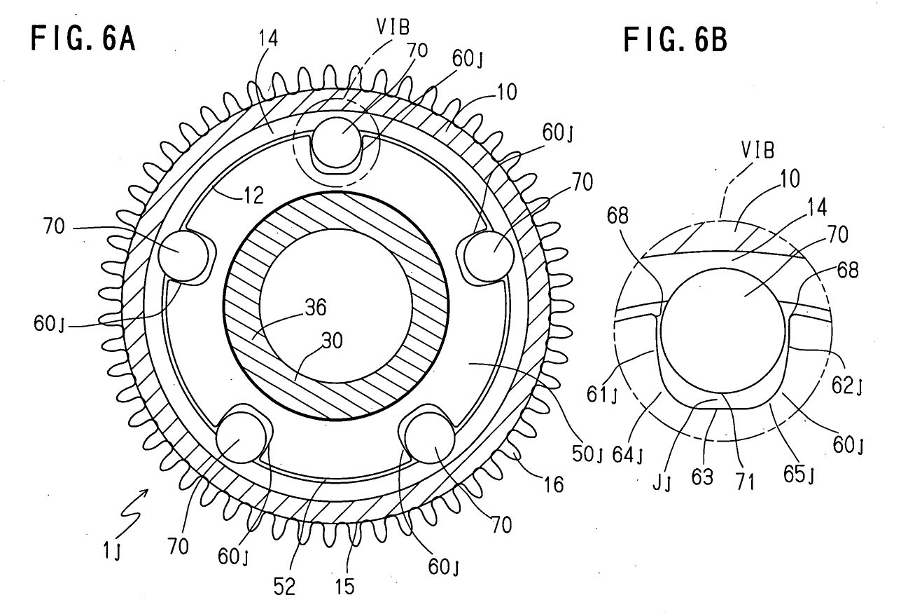

As shown in FIGS. 6A and 6B, a ball bearing device 1j can be equipped with a retainer 50j having recessed sections 60j each provided with sidewall sections 61j, 62j concavely curved towards the opposing sidewall section. In this case, the curvature radius of the concavely curved section does not make any difference as long as the concavely curved sections have the curvature radius large enough for the contact between the concavely curved section of each of the sidewall sections 61j, 62j and the convexly curved section of the spherical surface of the ball 70 to be kept as a point contact in actuality, and also for the force exerting on the retainer 50j to be regarded as substantially in the circumferential direction.

In FIGS. 6A and 6B, the same components, elements, and sections as those of the ball bearing device 1 shown in FIGS. 1 through 3 are denoted with the same reference numerals, and those corresponding but partially different are denoted with the reference numerals with a subscript of j.

In the ball bearing device 1j, curved sections 64j, 65j adjacent to the bottom section have a smaller curvature radius than the radius of the ball 70 similarly to the curved sections 64, 65. Note that, since the sidewall sections 61j, 62j are concavely curved, the sidewall sections 61j, 62j incline so as to go further from each other in the more outer sections, and accordingly, if the curved section is formed of a part of a circle, the curved section becomes a circular arc with a center angle smaller than 90 degrees. Except for this point, the curved sections are configured similarly to the curved sections 64, 65.

Also in this ball bearing device 1j, since the ball 70 does not abut on the bottom wall section 63 or the curved sections 64j, 65j adjacent thereto in the recessed section 60j whether or not the retainer 50j is positioned eccentrically, there is no possibility that the ball 70 applies the force in the radial direction to the retainer 50j via the recessed section 60j. Further, also in this ball bearing device 1j, since the ball 70 exerts the force substantially in the circumferential direction of the retainer 50j on the sidewall sections 61j, 62j of the recessed section 60j whether or not the retainer 50j is positioned eccentrically, there is less possibility that the ball 70 deforms the sidewall sections 61j, 62j of the retainer 50j and so on in the thickness direction, thus the retainer 50h can smoothly be rotated. Therefore, in the ball bearing device 1j equipped with the retainer 50j, the outer ring 10 can smoothly be rotated with respect to the inner ring 40 regardless of the posture and so on.

Further, also in the ball bearing device 1j, since a gap Jj is formed between the bottom wall section 63 of the recessed section 60j and the opposing surface section 71 of the ball 70, even if the fine powder arises, the fine powder can be stored in the gap Jj functioning as a dust hole in any way, thus the operations of the ball 70 of the ball bearing device 1j are maintained stable for a long period of time with ease.

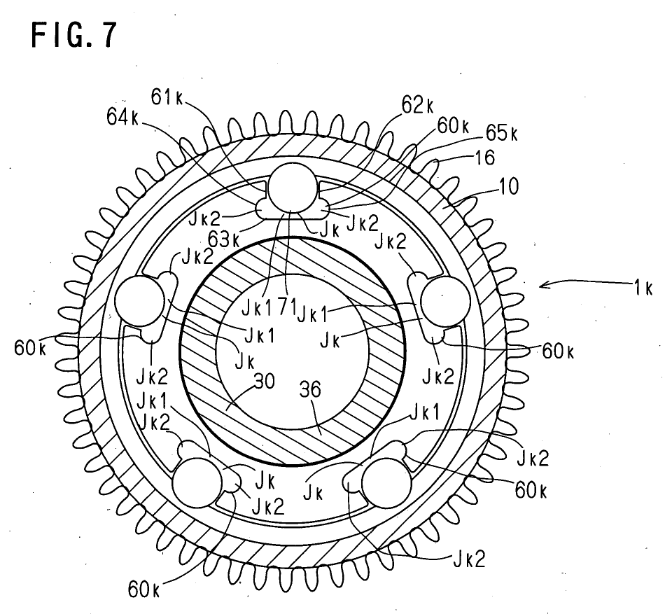

Further, as shown in FIG. 7, the ball bearing device can have a large gap Jk functioning as a dust hole. In FIG. 7, the same components, elements, and sections as those of the ball bearing device 1 shown in FIGS. 1 through 3 are denoted with the same reference numerals, and those corresponding but partially different are denoted with the reference numerals with a subscript of k.

In the ball bearing device 1k, the recessed section 60k has short sidewall sections 61k, 62k. In this case, the length and extending range of the sidewall sections 61k, 62k are selected so that the surface of the ball 70 oriented in the circumferential direction can abut on either of the sidewall sections 61k, 62k no matter what eccentric positions the retainer 50k is positioned at. Therefore, the relationship between the retainer 50k and the ball 70 accommodated in the recessed section 60k involved in the relative rotation between the inner ring 40 and the outer ring 10 is the same as the case with the ball bearing device 1, 1g, 1h, or 1j described above.

In the ball bearing device 1k, the retainer 50k is provided with curved wall sections 64k, 65k concaved significantly between the short sidewall sections 61k, 62k and the bottom wall section 63k elongated in the circumferential direction to form spaces Jk2 in front of the curved wall sections 64k, 65k. The spaces Jk2 are combined with a gap or a space Jk1 between the bottom wall section 63k and the opposing surface section 71 of the ball 70 to form the large space Jk as a whole and function as a dust hole. In the ball bearing device 1k, since a dust such as a fine powder dust can enter deeply into the spaces Jk2, in the case in which the fine powder dust is mixed with the lubrication oil, for example, the fine powder dust enters into the spaces Jk2 with the lubrication oil, thus the fine powder dust can be distanced from an adjacent area to the ball 70. Therefore, the ball bearing device 1k can stably be operated for a long period of time with ease.

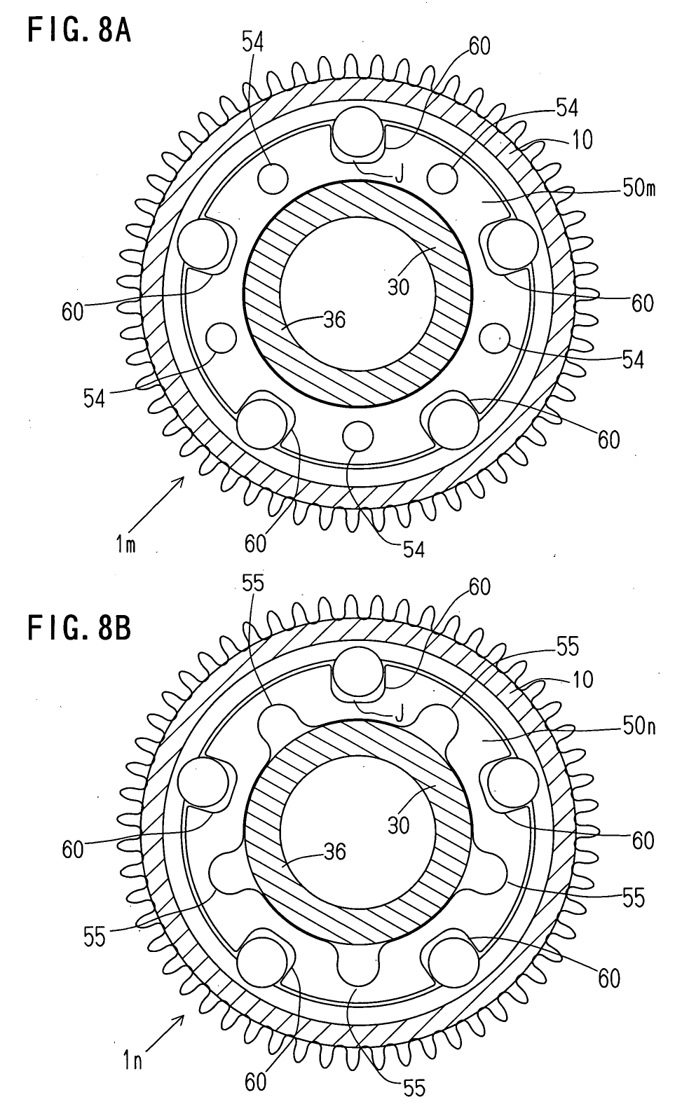

Since the retainer is for preventing the balls 70 from interfering with each other to make each of the balls 70 easily and surely rotate, it is not preferable for the retainer to be excessively heavy or to have excessively large inertia moment. Therefore, as shown in FIGS. 8A and 8B, holes or openings 54 or notches 55 can be provided to a retainer 50m, if desired, as long as the rigidity of the retainer 50m or 50n is not lowered. Note that, in ball bearing devices 1m and 1n shown in FIGS. 8A and 8B, the same components, elements, and sections as those of the ball bearing device 1 shown in FIGS. 1 through 3 are denoted with the same reference numerals, and those corresponding but partially different are denoted with the reference numerals with a subscript of m or n.

The ball bearing device 1m or 1n equipped with the retainer 50m or 50n can function similarly to the ball bearing device 1 shown in FIGS. 1 through 3, and further, since the retainer 50m or 50n is light weight and accordingly the balls 70 can easily rotate, the outer ring 10 can smoothly and easily be rotated relatively to the inner ring 40.

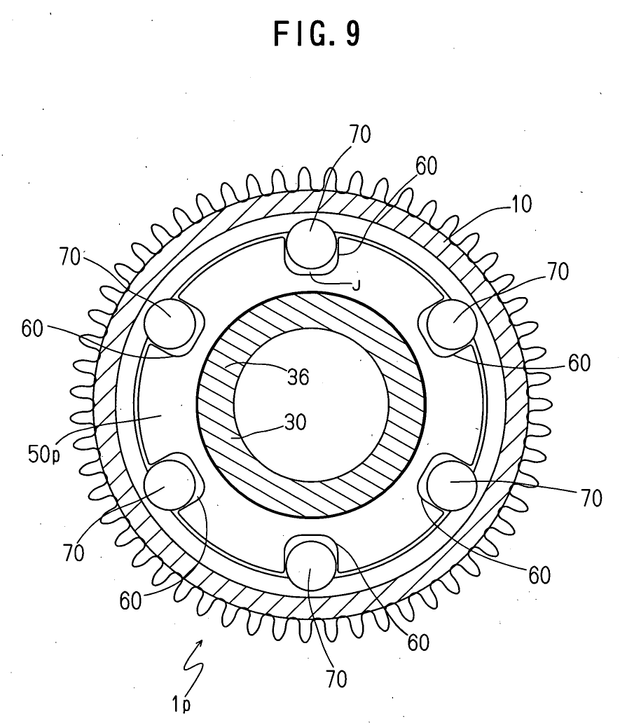

Note that although the example in which the number of recessed sections of the retainer and the number of the balls 70 are five is described above, the number of the recessed sections of the retainer and the number of the balls can be six or more, or as the case may be, they can be less. A ball bearing device 1p shown in FIG. 9 is the same as the ball bearing device 1 shown in FIGS. 1 through 3 except for the point that the number of the recessed sections 60 of a retainer 50p and the number of the balls 70 are six. Note that, in the ball bearing device 1p shown in FIG. 9, the same components, elements, and sections as those of the ball bearing device 1 shown in FIGS. 1 through 3 are denoted with the same reference numerals, and those corresponding but partially different are each denoted with the reference numeral with a subscript of p.

It might be obvious that the ball bearing device 1p can function similarly to the ball bearing device 1 or the like.

Further, in a ball bearing device, the retainer can be, instead of a plain plate with a constant thickness, composed of a plurality of sections or regions each having a different thickness or can be a structure formed by integrating a plurality of components.

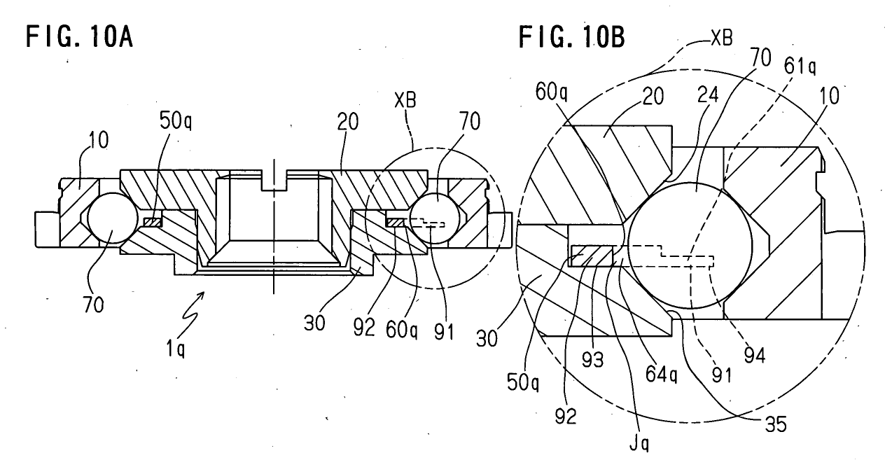

FIGS. 10A and 10B show a ball bearing device 1q having a retainer 50q in which an outer periphery section 91 positioned outer in the radial direction is thinner than an inner periphery section 92 positioned inner in the radial direction and forming a main body section, and the thin-wall outer periphery section 91 is provided with a principal surface 94 in the same level as one principal surface 93 of the thick-wall inner periphery section 92.

In further detail, a sidewall sections 61q, 62q (not shown) of a recessed section 60q of the retainer 50q are formed to be a thin-wall forming a part of the outer periphery section 91, and curved sections 64q, 65q (not shown) and a bottom section 63q are formed to be a thick-wall forming a part of the inner periphery section 92.

In the ball bearing device 1q, similarly to the ball bearing devices 1, 1g, 1h, 1j, 1k, 1m, 1n, and 1p, since strong force for deforming the outer periphery section of the peripheral wall of the recessed section of the retainer in the thickness direction is hardly exerted compared with the conventional ball bearing device 101, the outer periphery section 91 can be formed relatively thin, and by forming the outer periphery section 91 to be a thin-wall, the inertia moment of the retainer 50q can be reduced to the minimum, thus making the initial motion easy to be performed.

Note that in the ball bearing device 1q, since the thin-wall outer periphery section 91 is located in one side (the lower side in the example shown in FIGS. 10A and 10B) of the thick-wall inner periphery section 92 in the thickness direction, the inclined circular section 24, for example (in the case of the example shown in the drawings), can be positioned more inner than the inclined circular section 35 in the radial direction so that the outer periphery section 91 can be positioned adjacent to the center of the ball 70 in the middle of the shaft section 36 in the length direction. In this case, if the ball bearing device 1q is used for the automatic winding mechanism for timepieces or the like, the length of the shaft section 36 and the radial positions (diameters) of the inclined circular sections 24, 35 can be determined taking the posture (orientation) of the timepiece in ordinary use and changes in the posture (orientation) of the timepiece when the timepiece left on a table or the like for storage is taken up into consideration.

In the ball bearing device 1q shown in FIGS. 10A and 10B, the same components, elements, and sections as those of the ball bearing device 1 shown in FIGS. 1 through 3 are denoted with the same reference numerals, and those corresponding but partially different are each denoted with the reference numeral with a subscript of q.

It might be obvious that the ball bearing device 1q can also function similarly to the ball bearing device 1 described above or the like.

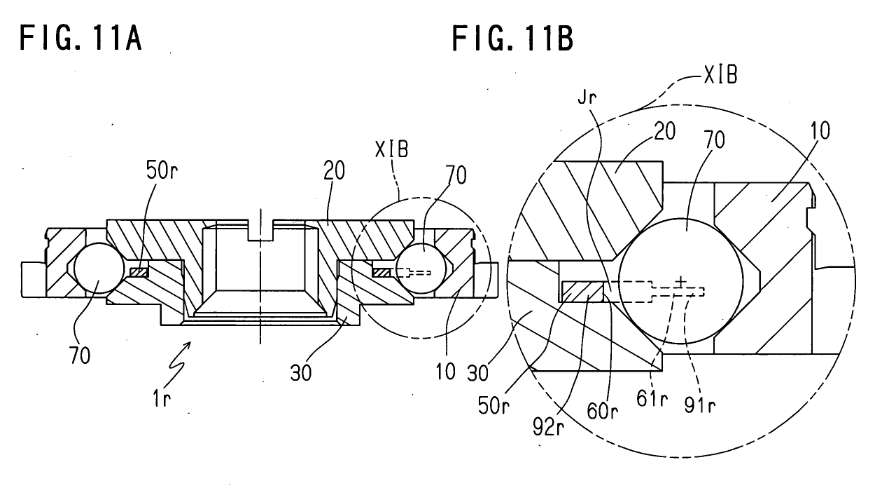

Note that a ball bearing device 1r shown in FIGS. 11A and 11B is similarly configured to the ball bearing device 1q shown in FIG. 10 except for the point that a thin-wall outer periphery section 91r is located in the middle of a thick-wall inner periphery section 92r in the thickness direction.

In the ball bearing device 1r shown in FIGS. 11A and 11B, the same components, elements, and sections as those of the ball bearing device 1 shown in FIGS. 1 through 3 or of the ball bearing device 1q shown in FIGS. 10A and 10B are denoted with the same reference numerals, and those corresponding but partially different are each denoted with the reference numeral with a subscript of r.

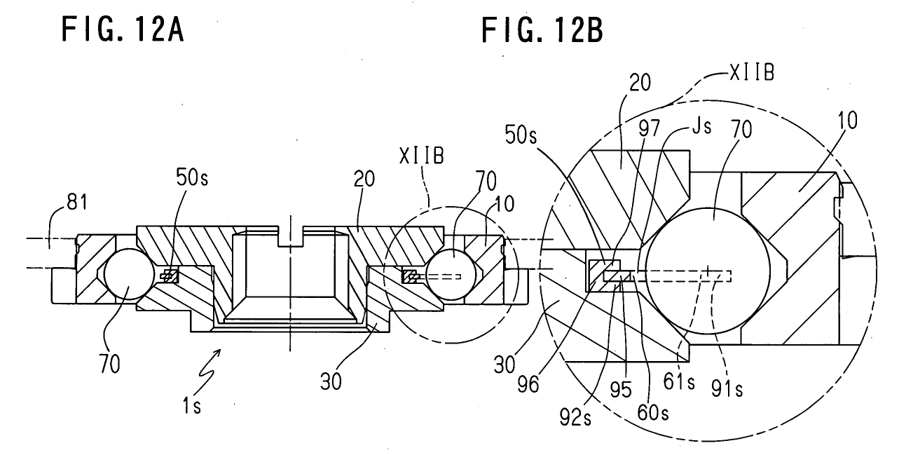

A ball bearing device 1s shown in FIGS. 12A and 12B is similarly configured to the ball bearing device 1r shown in FIG. 11 except for the point that a retainer 50s is composed of an inner thick-wall circular ring section 92s and an outer periphery thin-wall circular ring plate section 91s, which is fitted to a circular groove 95 formed in the axial center part of the outer peripheral surface of the thick-wall circular ring section 92s and is provided with recessed sections 60s. Note that in assembling the retainer 50s, an edge side ring section 97 of the thick-wall circular ring section 92s can be caulked so as to be fallen down towards the outer periphery after the thin-wall circular ring plate section 91s is fitted to, for example, a smaller diameter section 96 forming a bottom wall of the circular groove 95 of the thick-wall circular ring section 92s, or the thick-wall circular ring section 92s can be formed to have a shape of a c-ring.

In the ball bearing device is shown in FIGS. 12A and 12B, the same components, elements, and sections as those of the ball bearing device 1 shown in FIGS. 1 through 3 or of the ball bearing device 1r shown in FIGS. 11A and 11B are denoted with the same reference numerals, and those corresponding but partially different are each denoted with the reference numeral with a subscript of s.

It might be obvious that the ball bearing devices 1r and 1s can also function similarly to the ball bearing device 1 described above or the like.

Note that although the examples in which the ball bearing device is applied to the oscillation weight for automatic winding timepieces are described above, the ball bearing device according to the invention can be applied to every device in which the inner ring and the outer ring are relatively rotated. The ball bearing device according to the invention provides the advantages described above even when applied to, for example, a device in which the outer ring is rotated with respect to the inner ring, or the inner ring is rotated with respect to the outer ring, continuously in one direction.

What is claimed is:

1. A ball bearing device comprising:
an outer ring;
an inner ring;
a plurality of balls disposed between the outer ring and the inner ring in a radially restricted state; and
a retainer provided with a plurality of recessed sections, each having an opening in the outer periphery, at intervals in the circumferential direction for holding the balls at intervals in the circumferential direction and rotatably fitted to the inner ring,
wherein each of the recessed sections of the retainer is formed deeper and wider than the ball in a bottom wall side of each of the recessed sections so that a gap remains between a surface of the ball radially restricted between the outer ring and the inner ring and a bottom wall surface of each of the recessed sections, and is capable of abutting on the surface of the ball opposing in a circumferential direction in surface sections adjacent to the opening of each of the recessed sections.

2. A ball bearing device according to claim 1, wherein the surface sections adjacent to the opening of each of the recessed sections extend linearly.

3. A ball bearing device according to claim 1, wherein a distance between the surface sections adjacent to the opening of each of the recessed sections capable of abutting on the surface of the ball opposing in the circumferential direction is smaller at positions toward the outer radial direction.

4. A ball bearing device according to claim 1, wherein the surface sections adjacent to the opening of each of the recessed sections are convexly curved with respect to opposing ones of the surface sections.

5. A ball bearing device according to claim 1, wherein the surface sections adjacent to the opening of each of the recessed sections are concavely curved with respect to opposing ones of the surface sections.

6. A ball bearing device according to claim 1, wherein each of the recessed sections is provided with a dust hole section expanded in the circumferential direction adjacent to a bottom section of each of the recessed sections.

7. A ball bearing device according to claim 1, wherein the retainer includes a notch section.

8. A ball bearing device according to claim 7, wherein in the retainer, an outer section in the radial direction is thinner than an inner section in the radial direction.

9. A ball bearing device according to claim 8, wherein an outer section in the radial direction of the retainer capable of abutting on a surface section of the ball oriented in the circumferential direction is formed as a thin-wall section.

10. A ball bearing device according to claim 8, wherein the retainer includes a thick-wall ring section positioned inner in the radial direction and a thin-wall ring section fitted to the thick-wall ring section in an inner peripheral side and positioned outer in the radial direction.

11. A ball bearing device according to claim 1, wherein an inner peripheral surface of the outer ring includes two inclined circular surfaces, the inner ring includes an inner ring body with an inclined circular outer peripheral surface and a holding ring with an inclined circular surface and fitted to the inner ring body, and the holding ring includes a cylindrical section rotatably fitted to the retainer, and positioned between the inclined circular surface of the inner ring body and the inclined circular surface of the holding ring.

12. An oscillating weight structure for automatic winding, comprising the ball bearing device according to claim 1, wherein the outer ring of the ball bearing device is fixed to an oscillating weight.

13. An automatic winding timepiece comprising a ball bearing device and the oscillating weight structure for automatic winding according to claim 12.
